(19) United States
(12) Patent Application Publication
(10) Pub. No.: US 2026/0254817 A1
(43) Pub. Date: Aug. 27, 2026

(54) APPLYING ACCESS POLICIES IN STREAM PROCESSING

(71) Applicant: INTERNATIONAL BUSINESS MACHINES CORPORATION, ARMONK, NY (US)

(72) Inventors: Aiden John Gallagher, York (GB); David Michael McCallum Hay, Andover (GB); Andrew Mark Garratt, Andover (GB); Dale Lane, Eastleigh (GB)

(21) Appl. No.: 19/062,320

(22) Filed: Feb. 25, 2025

(30) Foreign Application Priority Data
Oct. 7, 2024 (GB) 2414713.4

(51) Int. Cl. H04L 9/40

(52) U.S. Cl. CPC H04L 63/105

(57) ABSTRACT

An approach is provided for applying access policies in stream processing. A message data structure is provided for a message in a stream processing system. The message data structure has multiple fields. Multiple role-based access levels are defined for the message by defining, for each level, access to selected allowed fields in the data structure. Access level streams only having access to the defined allowed fields are created and an associated access level schema is pushed to a schema registry. When receiving inbound data for the message, each defined access level is applied to the inbound data to put data into each access level stream. When receiving a consumer request for access to the message, the consumer access level is checked and access is provided to an appropriate access level stream.

### BACKGROUND

The present invention relates to stream processing, and more specifically, to applying access policies in stream processing.

In computer science, stream processing is a programming paradigm which views streams (or sequences of events in time) as the central input and output objects of computation.

As streaming platforms become the central nervous system of enterprises, it is crucial to ensure security of streaming data. Examples of streaming platforms include: Apache Kafka (Apache Kafka is a trademark of Apache Software Foundation), Apache Pulsar (Apache Pulsar is a trademark of Apache Software Foundation), Microsoft Azure Event Hubs (Microsoft Azure Event Hubs is a trademark of Microsoft Corporation), and RabbitMQ Streams (RabbitMQ is a trademark of Broadcom, Inc.). Role-Based Access Control (RBAC) is one of the most common ways to provide security for data in streaming platforms.

When applications access a data stream by subscribing to one or more message topics, all data is available to any person with permission to that topic of data. There is no easy way today, to restrict which data fields are accessed based on the user or group permissions without manipulating the data on entry or exit. This requires the use of a gateway or transformation tool which increases cross-dependency.

Access control privileges are defined in a RBAC service to determine which role can access streaming data. Stream-processing platforms are optimized for write once, read many. If a role-based access control (RBAC) policy is applied each time the stream is read, this may quickly mean applying policies 100s and 1000s of times using logic to remove or add specific fields depending on the permissions of the accessing user.

### SUMMARY

According to an aspect of the present invention there is provided a computer-implemented method for applying access policies in stream processing. The method includes: providing a message data structure for a message in a stream processing system, where the message data structure has multiple fields; defining multiple role-based access levels for the message by defining, for each level, access to selected allowed fields in the data structure; creating access level streams only having access to the defined allowed fields and pushing an associated access level schema to a schema registry; when receiving inbound data for the message, applying each defined access level to the inbound data to put data into each access level stream; and, when receiving a consumer request for access to the message, checking the consumer access level and providing access to an appropriate access level stream.

According to another aspect of the present invention there is provided a system for applying access policies in stream processing. The system includes: a processor and a memory configured to provide computer program instructions to the processor to execute a method. The method includes: providing a message data structure for a message in a stream processing system, where the message data structure has multiple fields; defining multiple role-based access levels for the message by defining, for each level, access to selected allowed fields in the data structure; creating access level streams only having access to the defined allowed fields and pushing an associated access level schema to a schema registry; when receiving inbound data for the message, applying each defined access level to the inbound data to put data into each access level stream; and, when receiving a consumer request for access to the message, checking the consumer access level and providing access to an appropriate access level stream.

According to a further aspect of the present invention there is provided a computer program product for applying access policies in stream processing. The computer program product includes a computer readable storage medium having program instructions stored in the computer readable storage medium, the program instructions executable by a processor to cause the processor to: provide a message data structure for a message in a stream processing system, where the message data structure has multiple fields; define multiple role-based access levels for the message by defining, for each level, access to selected allowed fields in the data structure; create access level streams only having access to the defined allowed fields and push an associated access level schema to a schema registry; when receiving inbound data for the message, apply each defined access level to the inbound data to put data into each access level stream; and, when receiving a consumer request for access to the message, check the consumer access level and provide access to an appropriate access level stream.

### BRIEF DESCRIPTION OF THE DRAWINGS

FIG. 1 is a block diagram of an example embodiment of a data streaming environment in which embodiments of the present invention may be implemented. FIG. 2 is a flow diagram of an example embodiment of a method in accordance with embodiments of the present invention. FIG. 3 is a block diagram of an example embodiment of a system in accordance with embodiments of the present invention. FIG. 4 is a block diagram of an example embodiment of a computing environment for the execution of at least some of the computer code involved in performing embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for applying access policies in stream processing. Streaming platforms provide access for applications to a data stream by the applications subscribing to one or more message topics and consuming messages pushed on that topic. Role-Based Access Control (RBAC) is used in streaming platforms to provide security for data by permitting access to message topics based on roles of the consumers.

When applications access a data stream by subscribing to one or more message topics, conventionally all data fields are available to a consumer with permission to that topic of data. The described method and system address this problem by dynamically and transparently creating schema-specific streams for topics for role-based access.

The method and system take as input a message data structure for a message in a stream processing system, where the message data structure has multiple fields. Multiple role-based access levels for the message are defined by defining access for each level to allowed fields in the data structure. Access level streams are then created with each access level stream only having access to the defined allowed fields for that access level. An access level schema for each access level stream may be created and pushed to a schema registry.

When the streaming platform receives inbound data for the message, each defined access level is applied to the inbound data to put the inbound data into an access level stream. When a consumer requests access to the message from the streaming platform, the consumer access level is checked and access provided to an appropriate access level stream.

The method and system create streams of topics based on a main stream, where each topic has a role-based schema policy applied to it. This means each consumer only has access to the set of data they are permitted to view, which is determined when the message is written not when then message is read. This reduces the number of actions applied to data streams and makes role-based specific data instantly accessible. The end users are not aware of what data they cannot view from the main stream, which enhances security.

This method may be used to provide an immutable audit trail showing which data fields users had access to with their specific role at any time. Additionally, an audit stream can show which users accessed which data from which stream and at what time. Collectively, these improve the data security and governance of data stream and topic systems.

Creating access level streams means each user has access to the set of data they are permitted to view, which is determined when the message is written not when then message is read. This vastly reduces the number of actions applied to data streams and makes role-based specific data instantly accessible, but without end users being aware of what data they cannot view from the main stream, which enhances security.

The following definitions are provided. A “message” is a segment of data of information. A “stream of data” is a persistent ordered collection of messages. “Access policies” are a set of rules to read, write or alter messages on a stream.

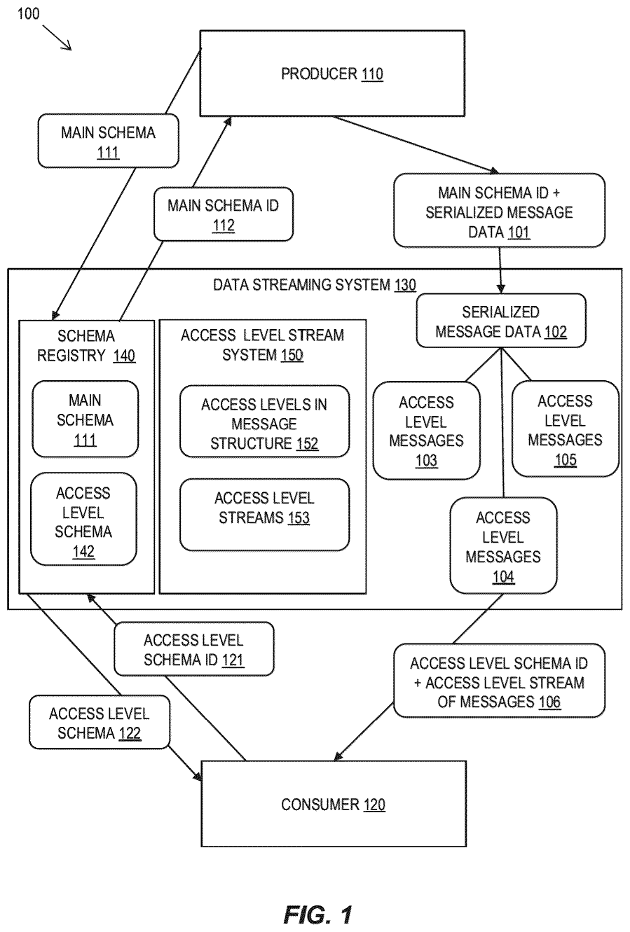

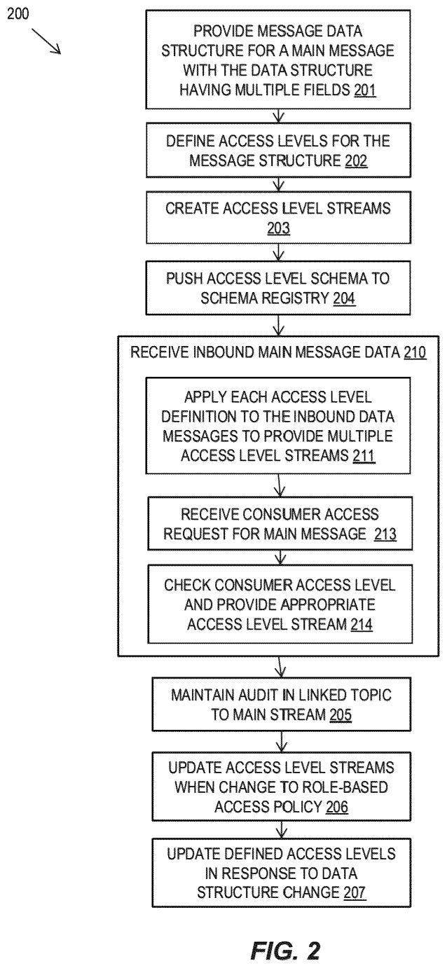

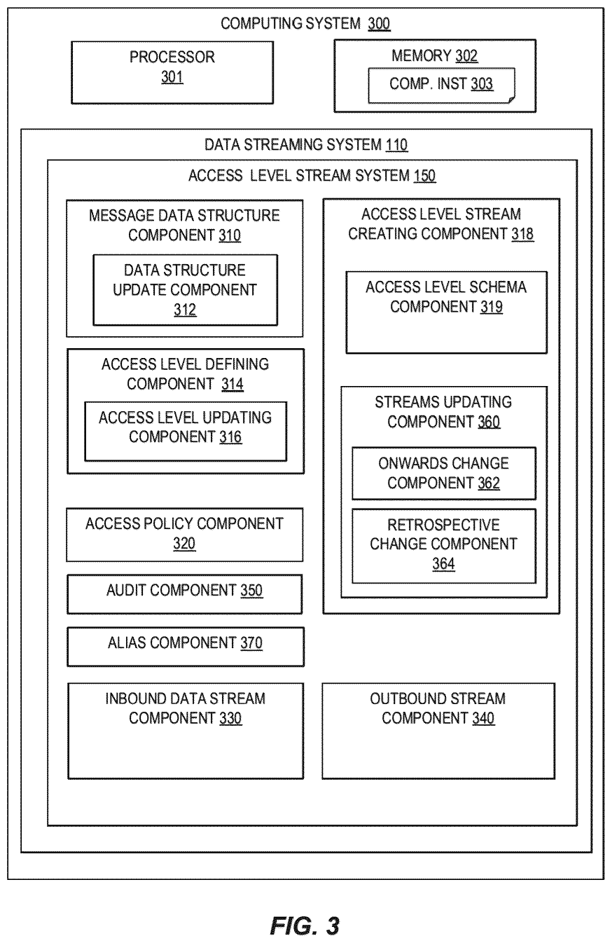

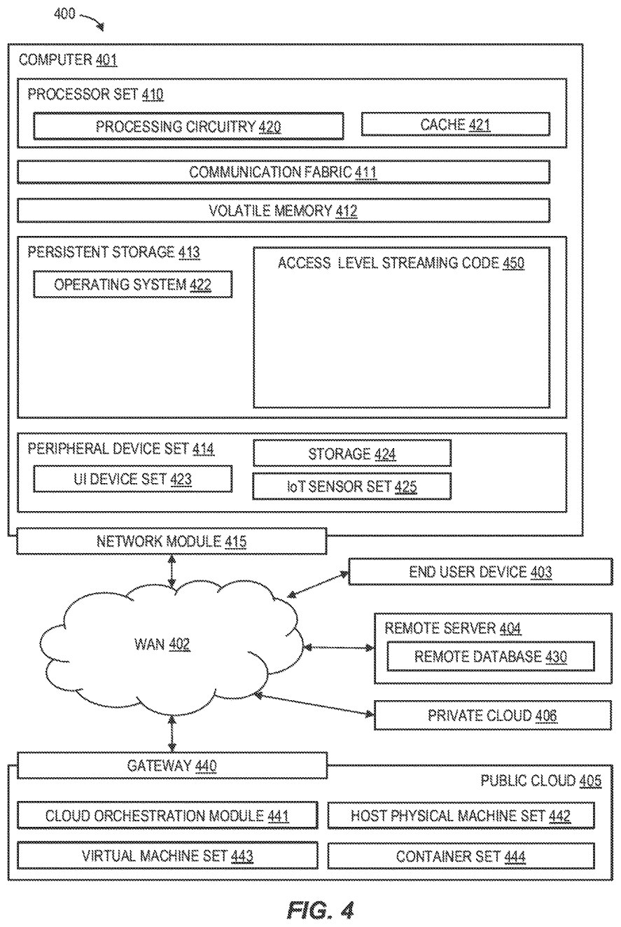

Referring to FIG. 1, a block diagram shows an example embodiment of a data streaming environment 100 in which the described method and system may be implemented to provide role-based access level streaming of data. The environment 100 includes a data producer 110 that streams data to a data streaming service 130 for consumption by a consumer 120 by the consumer subscribing to topics that are provided by the producer 110.

A schema registry 140 is used in the data streaming system 130 to maintain a database of schemas for messages processed between the producer 110 and consumer 120.

In an illustrated scenario, the producer 110 sends serialized message data 101 for a main message together with a main schema identifier. The producer 110 provides the main schema 111 for the main message to the schema registry 140 to obtain the main schema identifier 112.

The described functionality is provided by an access level stream system 150 at the data streaming service 130 that applies role-based access policies to produce access level data streams 153 for different access levels of consumers 120. The access level data streams 153 include fields of the main message that are allowed to be consumed by an access level. The access level stream component 150 defines access levels in a message structure 152 for generating the access level streams 153.

The produced serialized message data 101 of the main message is received at the data streaming service 130 as the serialized message data 102 and converted into multiple messages 103-105 on each of the access level streams 153 provided for the message structure of the main message. Each of the multiple messages 103-105 has an access level schema 142 that is pushed to the schema registry 140. A consumer 120 receives an appropriate access level stream of messages 106 with an access level schema identifier. The consumer 120 uses the access level schema identifier 121 to obtain the access level schema 122 from the schema registry 140 in order to correctly interpret the fields of the access level streamed message data structure.

Referring to FIG. 2, a flow diagram 200 shows an example embodiment of a method as carried out at a data streaming system to provide role-based access level streaming of data.

The method may provide 201 a message data structure for a main message in a stream processing system with the message data structure having multiple fields of data. The message data structure may be provided in a main stream, with the main stream allowing access to all fields in the message data structure and having a main schema (which is the complete schema) provided to a schema registry.

The method defines 202 multiple role-based access levels for the message by defining access for each level to selected allowed fields in the data structure. Defining 202 multiple role-based access levels may, for each field, define allowed or denied access for an access level. The access levels may be defined based on an access policy.

The method creates 203 access level streams only having access to the defined allowed fields. The access level streams may be considered sub-topics of the topic of the main message; however, a consumer need not be aware of subscribing to the sub-topic. The method dynamically creates role-based customized sub-topics linked to a main data topic by applying role specific data streams and schemas. The method creates and pushes 204 an associated access level schema for each access level to a schema registry. This may be pushed to the schema registry when the access level stream is created or when a first inbound message is received for an access level stream.

When inbound data for the main message is received 210, the method applies 211 each defined access level to the inbound data to put data into each access level stream.

When a consumer request is received 213 to access to the main message, the method checks 214 the consumer access level and provides access to an appropriate access level stream.

The method may include maintaining 205 an audit for the main stream that stores access information for each access level stream. This provides the ability to audit multiple dynamically created and torn-down sub-topics of a main topic, without risk of losing audit data. The audit trail demonstrates the full schema at the time of access, showing who could have seen what data at that specific time.

The method may include updating 206 the access level streams when changes to access levels are made. Access levels may be based on an access policy and the method may update access level streams when there is a change to an access policy. This supports ongoing changes to policies within a sub-topic at the point of application and retrospective application of policies to pre-existing data.

The method may also include updating 207 defined access levels in response to a change in the data structure of the message.

The described method provides transparent updating of data access for users accessing the same main topic through sub-topics. If the schema changes, the user no longer has access or knowledge of previous data but they are not impacted in their connectivity to the topics.

The following example illustrates the described method and shows an example of a company with customer records with different user groups.

The main Message is an “Updated Customer Record”.

The “Customer Record” has a data structure with the following fields:
CustomerNumber:
FirstName:
LastName:
email:
CreditLimit:
CurrentBalance:
Securitychecked:

The Main Message Stream is “Customer_Records”. By default, all users can see all fields of the “Customer Record”. To limit access for specific users, stream administrators put specific policies in place.

The following Access Policies are defined:
Level 10: Can see Customer Number, First Name, Last Name;
Level 20: Can see level 10+Email;
Level 30: Can see level 20+Current Balance;
Level 40: Can see all data.

The following Access Levels are defined with allowed and denied data field access:
Field 10 20 30 40
   CustomerNumber Y Y Y Y
   FirstName Y Y Y Y
   LastName Y Y Y Y
   Email N Y Y Y
   CreditLimit N N N Y
   CurrentBalance N N Y Y
   Securitychecked N N N Y

The method generates access level streams based on each of these access levels resulting in a main “Customer_Records” stream as well as a Level 10 Stream, Level 20 Stream, Level 30Stream, Level 40 Stream. For example, as “Customer_Records_10” or “Customer_Records_ten” or “Customer_Records10” etc. The main topic of “Customer_Records” is not affected to give clear levels of isolation.

The following method is applied on inbound data to the stream:
A record arrives on the “Customer_Records” stream
   CustomerNumber: 1
   FirstName: John
   LastName: Doe
   Email: John. Doe@example. com
   CreditLimit: 200
   CurrentBalance: 400
   Securitychecked: N

This has a main or raw schema of “customer_schema” for the whole record.

The described method applies Access Level 10 to the record and puts the data on the “Customer_Records_10” stream. For example:
CustomerNumber: 1
FirstName: John
Lastname: Doe

The described method creates a schema called “Customer_Records_10_schema” and pushes it to the schema registry.

The described method applies Access Level 20 to the record and puts the data on the “Customer_Records_20” stream. For example:
CustomerNumber: 1
FirstName: John
LastName: Doe
Email: John. Doe@example. com

The described method creates a schema called “Customer_Records_20_schema” and pushes it to the schema registry.

The described method applies Access Level 30 to the record and puts the data on the “Customer_Records_30” stream. For example:
CustomerNumber: 1
FirstName: John
LastName: Doe
Email: John. Doe@example. com
Currentbalance: 400

The described method creates a schema called “Customer_Records_30_schema” and pushes it to the schema registry.

The described method applies Access Level 40 to the record and puts the data on the “Customer_Records_40” stream. For example:
CustomerNumber: 1
FirstName: John
LastName: Doe
Email: John. Doe@example. com
CurrentBalance: 400
Securitychecked: N

The described method creates a schema called “Customer_Records_40_schema” and pushes it to the schema registry.

A consumer requests access to stream “Customer_Records”.

The consumer access level is checked using RBAC methodologies (for example, using a Lightweight Directory Access Protocol (LDAP), local file, etc.) and they are assigned an access level number (10, 20, 30, 40), referred to as access level ‘N’.

The consumer is given access to the stream ‘Customer_Records_N’ and pointed at the schema ‘Customer_N_schema’

The stream may be an alias stream so that the consumer is not aware they are in a sub-stream or sub-topic. Alternatively, the policy stream may be directly used where consumers are aware of their sub-topic.

If a policy is updated in the RBAC system, for example, through polling or pushed changes from the RBAC such as a web hook.

There are two potential methods that may be applied and selected during the access level stream setup. The first provides policy changes from a change point onwards and the other provides policy changes retrospectively.

In the first case, the policy changes from a change point forward. The old policy has been applied to previous messages in the stream and then the new policy applies to new messages on the stream. The existing stream is maintained, and the changed data is applied from the offset at the time of the policy change acceptance by the stream processing capability.

For this use case, it is assumed that there is a Policy Version 1 which has been applied up to the current date. Policy Version 2 should be applied from the current data onwards. The existing sub-stream is maintained with its messages (i.e. all past messages have had Policy Version 1 applied). From the current time onwards, every new message on the sub-stream will have Policy Version 2 applied.

If a consumer reads a message that was written before the policy version was updated, they will get the message with Policy Version 1 applied as that was the policy in force at the time the message was written.

If a consumer reads a message that was written after the policy version was updated, they will get the message with Policy Version 2 applied as that was the policy version in force when that message was written.

This means that the sub-stream will have some messages with Policy Version 1 applied and some messages with Policy Version 2 applied to them—depending on which policy version was in force when the message was written.

In the second case, the policy change is retrospective and applies to all data, even historical data. The method calls for the deletion of the sub-stream for that policy, and a recreation applies the new policies for all data in the main stream.

For this use case, it is assumed that there is Policy Version 1 which has been applied up to the current date and from now on Policy Version 2 will apply.

For whatever reason, Policy Version 2 needs to be applied retrospectively to all messages on the sub-stream i.e. whenever a consumer reads any message on the sub-stream, Policy Version 2 needs to be applied. This could be for legal or regulatory reasons, for example, “As of <date>, no consumer will be able to have access to a customer's home phone number—even if they used to have access before”.

This means that the policy change to Policy Version 2 is applied retrospectively to all the messages on the sub-stream. This is carried out by rebuilding the sub-stream from the original stream and applying Policy Version 2 to all of the messages.

Once this is done, there will be no messages on the sub-stream with Policy Version 1 applied to them—all messages will have had Policy Version 2 applied.

In the event that a data structure changes, for example, a ‘Postcode’ is added to the Customer_Record and to the stream. The access level definitions are changed for the access level streams to hold the updated structure.

Audits may be retained in a linked topic to the main stream, for example, customer_stream_audit_topic. This stores information such as the date time, the access level stream identifier and who accessed it. For example, audit: 202311031101 stream_marketing_12887 accessed by Andy for period X. This may use a logging service rule to append updates to the audit topic or may use a custom authenticator library.

The described method has the following benefits. A policy enforcement event gateway is not required as policies are pre-applied before a user accesses the stream. The method reduces the number of actions applied to data streams by implementing policy at write time (once per message) and not read time (100s/1000s). The method creates an immutable audit trail and by default enhances security. The method improves data security and governance by isolating data for specific roles. The method provides greater flexibility for changes to data policies than existing products. The method also reduces complexity of policy creation because policies do not have to be temporally aware.

Referring to FIG. 3, a block diagram shows a computing system 300 in which a data streaming system 110 may be provided having a described access level stream system 150 for applying access policies in stream processing.

The computing system 300 may include at least one processor 301, a hardware module, or a circuit for executing the functions of the described components which may be software units executing on the at least one processor. Multiple processors running parallel processing threads may be provided enabling parallel processing of some or all of the functions of the components. Memory 302 may be configured to provide computer instructions 303 to the at least one processor 301 to carry out the functionality of the components.

The access level stream system 150 may include a message data structure component 310 for providing a message data structure for a message in a stream processing system with the message data structure having multiple fields. The message data structure component 310 may include a data structure update component 312 for updating a data structure.

The access level stream system 150 may include an access level defining component 314 for defining multiple role-based access levels for the message by defining, for each level, access to selected allowed fields in the data structure. The access level defining component 314 may include an access level updating component 316 for updating access levels.

The access level stream system 150 may include an access level stream creating component 318 for creating access level streams only having access to the defined allowed fields. The access level stream creating component 318 may include an access level schema component 319 for providing the access level schemas to the schema registry.

The access level stream creating component 318 may include a streams updating component 360 for updating the access level streams when changes to access levels are made. The streams updating component 360 may include an onwards change component 362 for updating access level streams for an access policy from a change point onwards with updated access level streams applied to new messages on a stream and retaining previous access level streams and applying the changed data from the offset at the time of the policy change acceptance. The streams updating component 360 may include a retrospective change component 364 for updating access level streams is retrospective by recreating all access level streams and deleting previous access level streams for an access policy.

The access level stream system 150 may include an access policy component 320 for defining multiple role-based access levels for an access policy.

The access level stream system 150 may include an audit component 350 for maintaining an audit for the main stream that stores access information for each access level stream.

The access level stream system 150 may include an alias component 370 for making an access level stream an alias stream so that a consumer is not aware of access restrictions to the main message.

The access level stream system 150 may include an inbound data stream component 330 for, when receiving inbound data for the message, applying each defined access level to the inbound data to put data into each access level stream and pushing an associated access level schema to a schema registry.

The access level stream system 150 may include an outbound stream component 340 for, when receiving a consumer request for access to the message, checking the consumer access level and providing access to an appropriate access level stream.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 4, computing environment 400 contains an example of an environment for the execution of at least some of the computer code involved in performing the inventive methods, such as access level streaming code 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

CLOUD COMPUTING SERVICES AND/OR MICROSERVICES (not separately shown in FIG. 4): private and public clouds 406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The aforementioned computer readable storage medium may be a non-transitory computer readable storage medium and the aforementioned computer readable program code may be executable by a processing circuit.

One or more embodiments of the present invention seek to provide one or more concepts for applying access policies to data streaming. Such concepts may be computer-implemented. That is, such methods may be implemented in a computer infrastructure having computer executable code tangibly embodied on a computer readable storage medium having programming instructions configured to perform a proposed method. One or more embodiments of the present invention further seek to provide a computer program product including computer program code for implementing the proposed concepts when executed on a processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of embodiments of the present invention.

What is claimed is:

1. A computer-implemented method for applying access policies in stream processing, said method comprising:
providing a message data structure for a message in a stream processing system, wherein the message data structure has multiple fields;
defining multiple role-based access levels for the message by defining, for each level, access to selected allowed fields in the data structure;
creating access level streams only having access to the defined allowed fields; and
pushing an associated access level schema to a schema registry;
when receiving inbound data for the message, applying each defined access level to the inbound data to put data into each access level stream; and
when receiving a consumer request for access to the message, checking the consumer access level and providing access to an appropriate access level stream.

2. The method of claim 1, wherein the defining multiple role-based access levels for the message by defining access for each level to allowed fields in the data structure includes, for each field, defining allowed or denied access for an access level.

3. The method of claim 1, wherein the messages of the message data structure are provided in a main stream with allowed access to all fields in the message data structure and having a main schema provided to the schema registry.

4. The method of claim 3, further comprising maintaining an audit for the main stream that stores stream and data access information including date and time for each access level stream.

5. The method of claim 1, further comprising updating the access level streams when changes to access levels or schema are made.

6. The method of claim 1, further comprising defining multiple role-based access levels for an access policy and updating the access level streams when there is a change to the access policy or message schema.

7. The method of claim 6, wherein the updating access level streams for an access policy is from a change point onwards with the updated access level streams applied to new messages on a stream and retaining previous access level streams and applying the access policy having the change from an offset at a time of an acceptance of the access policy change.

8. The method of claim 6, wherein the updating access level streams is retrospective by recreating all of the access level streams and deleting previous access level streams for the access policy.

9. The method of claim 1, further comprising updating defined access levels in response to a change in the data structure of the message.

10. The method of claim 1, wherein an access level stream is an alias stream so that a consumer is not aware of access restrictions to the message.

11. A system for applying access policies in stream processing, comprising:
a processor and a memory configured to provide computer program instructions to the processor to execute a method of:
providing a message data structure for a message in a stream processing system, wherein the message data structure has multiple fields;
defining multiple role-based access levels for the message by defining, for each level, access to selected allowed fields in the data structure;
creating access level streams only having access to the defined allowed fields; and
pushing an associated access level schema to a schema registry;
when receiving inbound data for the message, applying each defined access level to the inbound data to put data into each access level stream; and
when receiving a consumer request for access to the message, checking the consumer access level and providing access to an appropriate access level stream.

12. The system of claim 11, wherein the messages of the message data structure are provided in a main stream with allowed access to all fields in the message data structure and having a main schema provided to the schema registry.

13. The system of claim 12, wherein the method includes maintaining an audit for the main stream that stores stream and data access information date and time for each access level stream.

14. The system of claim 11, wherein the method includes updating the access level streams when changes to access levels or schema are made.

15. The system of claim 11, wherein the method includes defining multiple role-based access levels for an access policy and updating the access level streams when there is a change to the access policy or message schema.

16. The system of claim 15, wherein the updating access level streams for an access policy is from a change point onwards with the updated access level streams applied to new messages on a stream and retaining previous access level streams and applying the access policy having the change from an offset at a time of an acceptance of the access policy change.

17. The system of claim 15, wherein the updating access level streams is retrospective by recreating all of the access level streams and deleting previous access level streams for the access policy.

18. The system of claim 11, wherein the method includes updating defined access levels in response to a change in the data structure of the message.

19. The system of claim 11, wherein an access level stream is an alias stream so that a consumer is not aware of access restrictions to the message.

20. A computer program product for applying access policies in stream processing, the computer program product comprising a computer readable storage medium having program instructions stored in the computer readable storage medium, the program instructions executable by a processor to cause the processor to:
provide a message data structure for a message in a stream processing system, where the message data structure has multiple fields;
define multiple role-based access levels for the message by defining, for each level, access to selected allowed fields in the data structure;
create access level streams only having access to the defined allowed fields and push an associated access level schema to a schema registry;
when receiving inbound data for the message, apply each defined access level to the inbound data to put data into each access level stream; and,
when receiving a consumer request for access to the message, check the consumer access level and provide access to an appropriate access level stream.
